(19) United States
(12) Patent Application Publication
(10) Pub. No.: US 2011/0099845 A1
(43) Pub. Date: May 5, 2011

(54) CUSTOMIZED FOOTWEAR AND METHODS FOR MANUFACTURING

(76) Inventor: Michael J. Miller, Waunakee, WI (US)

(21) Appl. No.: 12/938,914

(22) Filed: Nov. 3, 2010

Related U.S. Application Data
(60) Provisional application No. 61/257,637, filed on Nov. 3, 2009.

(51) Int. Cl. A43B 7/22; A43B 13/12; A43B 7/16; B29D 35/00

(52) U.S. Cl. 36/91; 36/30 R; 36/92; 12/142 R

(57) ABSTRACT

Various embodiments of the invention include a customizable shoe for a user based at least in part upon pressure mapping data for that particular user. Additionally, various embodiments of the invention include methods of manufacturing a customizable shoe based upon pressure scanning the feet of a particular user.

### FIELD OF THE INVENTION

The present invention relates to footwear. More particularly, the present invention relates to footwear and midsoles customizable for different individuals and uses.

### BACKGROUND OF THE INVENTION

Different activities, such as, for example, running, walking, basketball, and tennis, have different performance requirements. By example, runners are exposed to repeated force in their feet, legs, and back, as their feet come into contact with the ground. The repeated force results in the transmission of ground reaction forces to the feet and other parts of the anatomy. Often knees, hips and other joints are confronted with these forces. Ground reaction forces are generally transmitted from the ground surface to the foot upon impact of the foot with the ground. Repeated exposure to ground reaction forces takes its toll on the human body, often times resulting in chronic injuries. In some instances, the injury is much more acute and occurs only after a short period of exposure to ground reaction forces.

Certain types of activities have particular performance requirements. For example, individuals engaged in cutting motions generally need more vertical stability (i.e. less compressibility) in the lateral forefoot region. Similarly, individuals engaged in activities that involve running need more vertical stability in the toe region to facilitate the toe-off phase of a typical gait. Consequently, it is desirable to design a shoe that reduces the effect of ground reaction forces transmitted to the wearer during the activities associated with an application without compromising the performance needs associated with the activities.

Manufacturers have experimented with various materials and designs with the goal of providing shock attenuation and energy absorption in the midsole of the shoe. The “one size fits all” approach used by a variety of prior shoe designs is often an inaccurate approach to addressing the shock attenuation needs of the wearer because people with the same shoe size may have markedly different physical characteristics, such as weight and distribution of weight. People with different physical characteristics frequently have different shock attenuation needs.

Therefore, there remains a need for a midsole design that allows the midsoles to selectively attenuate ground reaction forces by taking into consideration the physical characteristics of the people wearing the shoes and the performance requirements of the applications for which the shoes are worn. Notwithstanding the variety of prior shoe designs, there remains a need for shoe midsoles that provide the appropriate amount of shock attenuation in the appropriate areas of the feet to individuals engaged in particular types of activities.

Different individuals engaged in differing activities such as essentially linear running on various surfaces (road, trail, etc.); court activities such as basketball, badminton and tennis; cycling; walking/hiking on various surfaces and topographies; and turf activities such as soccer, football, rugby and lacrosse; each have different performance requirements determined by biomechanics, physiology, kinesiology and the activity itself. The repeated impact of the foot with the activity surface transfers the ground reaction forces through the individual's footwear upward through the body with each contact with the ground. Overtime, repeated impact adversely affects the body's ability to dissipate shock due to the overuse related damage to soft tissue, skeletal, and muscular structures. In some instances, physiological deterioration and resulting changes in kinesiology are related to the processes of natural aging.

Differing activities have equally differing performance characteristics. Movement of the body, especially the lower extremities, associated with linear running requires a limited amount of lateral foot movement related to side-to-side. Whereas, court and turf oriented activities consist of movements common with abrupt changes in direction. Individuals require shock attenuation consist with specific activity and individual physiology, biomechanics and kinesiology.

Based upon the varying needs of individuals not only based upon their specific physiology, but also the biomechanics of the particular activity they engage, it would be advantageous to have footwear that is designed for each individual based at least in part upon these needs. Furthermore, it would be advantageous if a pressure scan could be used to identify data that can be used for identifying the customizable portions of a shoe. Additionally, it would be advantageous if there was a dynamic process for manufacturing footwear that is customizable for a variety of individuals based at least in part upon pressure mapping data.

### BRIEF DESCRIPTION OF THE DRAWINGS

FIG. 1 is an exploded view of a shoe midsole in accordance with at least one embodiment of the present invention;

FIG. 2 is a top plan view of the midsole shown in FIG. 1;

FIG. 3 is a cross section along lines 3-3 of the midsole shown in FIG. 2;

FIG. 4 is an exploded view of an alternative shoe midsole in accordance with at least one embodiment of the present invention;

FIG. 5 is a top plan view of the midsole shown in FIG. 4;

FIG. 6 is an exploded view of an alternative shoe midsole in accordance with at least one embodiment of the present invention;

FIG. 7 is a top plan view of the midsole shown in FIG. 6;

FIG. 8 is a cross section along lines 8-8 of the midsole shown in FIG. 7; and

FIG. 9 is an exploded view of an exemplary show in accordance with at least one embodiment of the present invention.

### DETAILED DESCRIPTION OF THE PREFERRED EMBODIMENT

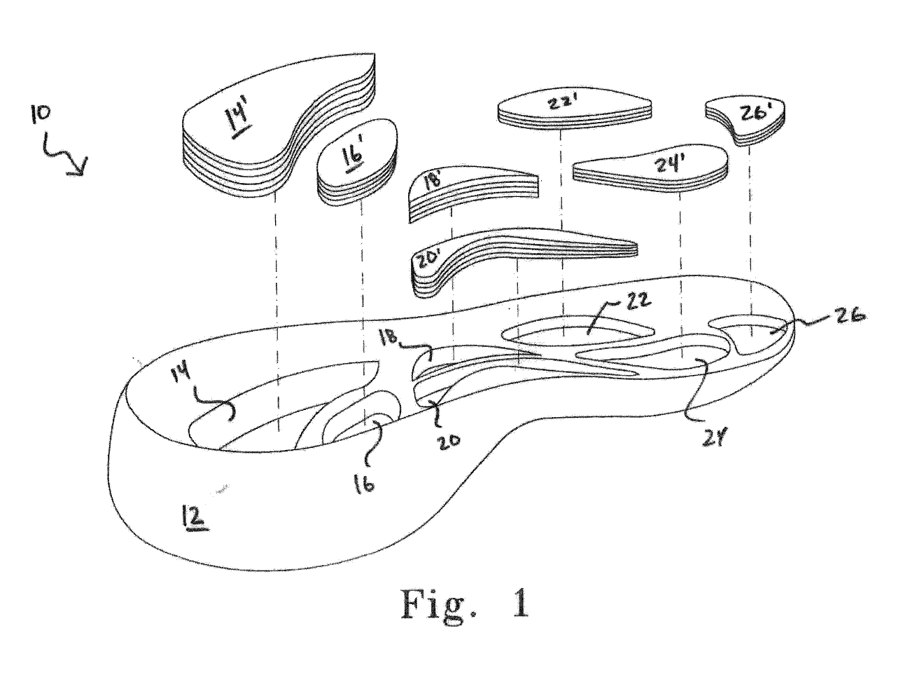

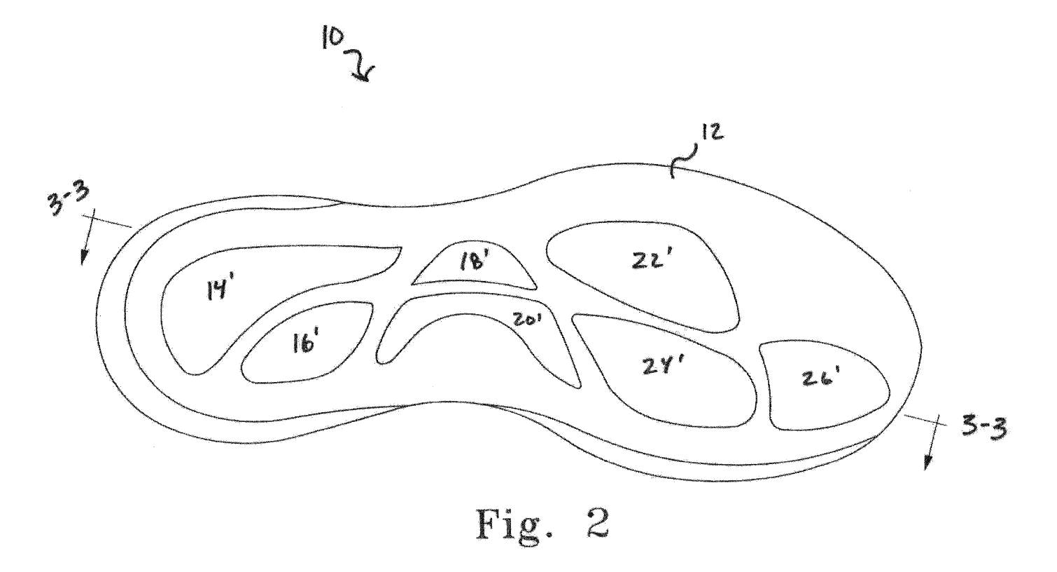

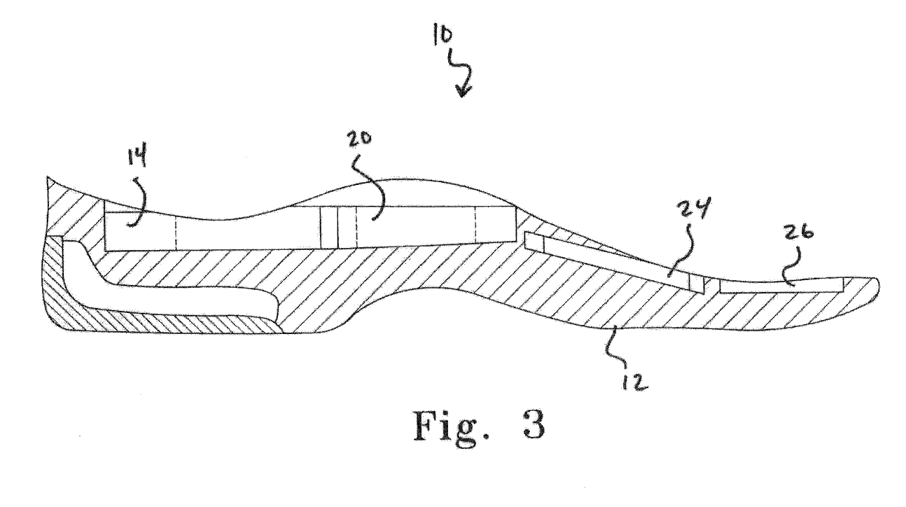

Referring to FIGS. 1-3, an exemplary footwear midsole 10 is provided. The midsole 10 includes a holder 12 and a plurality of compartments 14, 16, 18, 20, 22, 24, 26 and corresponding inserts 14′, 16′, 18′, 20′, 22′, 24′, 26′. In the present embodiment there are seven compartments and corresponding inserts that provide a customizable midsole for a user based in part upon a pressure mapping set of data. The pressure mapping data is obtained from a user having a pressure scan performed of at least one, or both, feet. The pressure mapping information is utilized for measuring the areas on a user's foot that require varying amount of support and facilitation for shock attenuation.

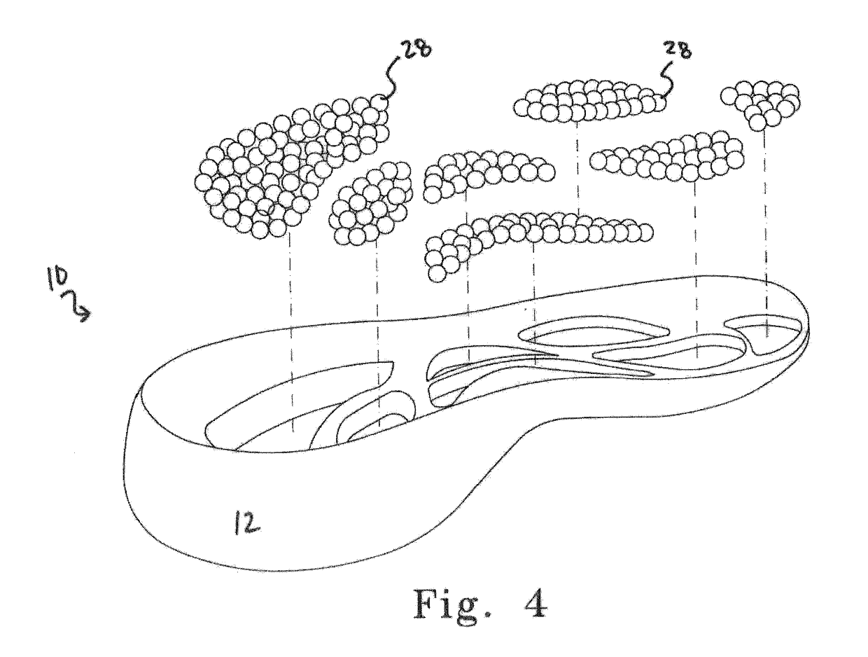

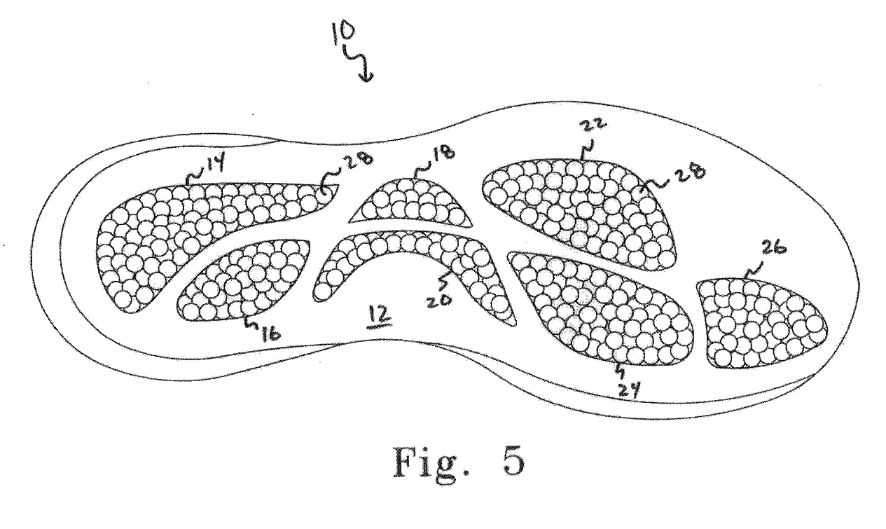

Referring to FIGS. 4-5 the midsole 12 is provided with an alternative insert embodiment. Cushion beads 28 are provided in place of layered inserts. The beads 28 are designed to fill the compartments based upon pressure mapping information. A variety of materials can be used. By example, general purpose foams are available in various hardnesses and densities. General purpose foams are compounded of EVA (Ethyl Vinyl Acetate)/PO (Polyolefin) microcellular raw materials to serve a wide variety of products and markets. Ultra soft foams serve a particular market where comfort, sealing properties, light weight and protection are required. The foams have been developed to a hardness of 20 Asker C, and range significantly (about 80% less and greater than 20 Asker C). Medical foams have developed medical consist of a very small particle that offers anti bacterial, anti fungal, disinfectant, non toxic and anti static properties. Shock absorbing foam are closed cell foams which are commonly found in orthopedic footwear, recreational protection, toys, helmet liners, exercise equipment, industrial equipment protection, and electronic product protection just to name a few. High resilience foam contain a modifier to allow for a less uniform microcellular structure. The purpose of this is to offer additional support and comfort over long term use. In an alternative embodiment, the shape of the compartments are modified based upon the particular pressure mapping date, or the number and position of compartments is modified based at least in part upon pressure mapping data. The shape of the compartments may be of a variety of geometric shapes including circular, oval, octagonal, etc. to further modify the shock attenuation provided by each compartment and associated insert.

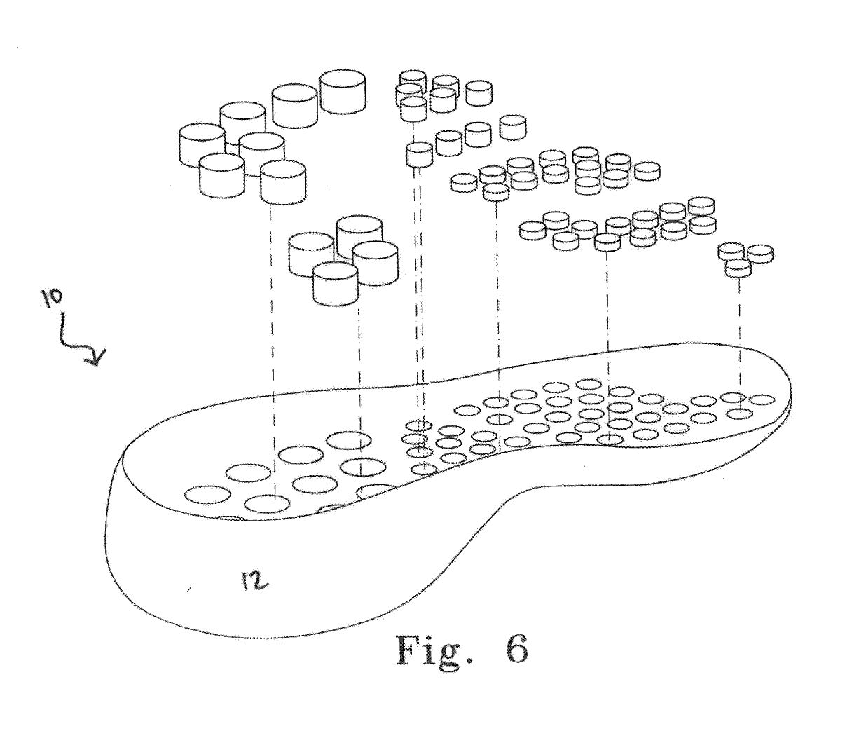

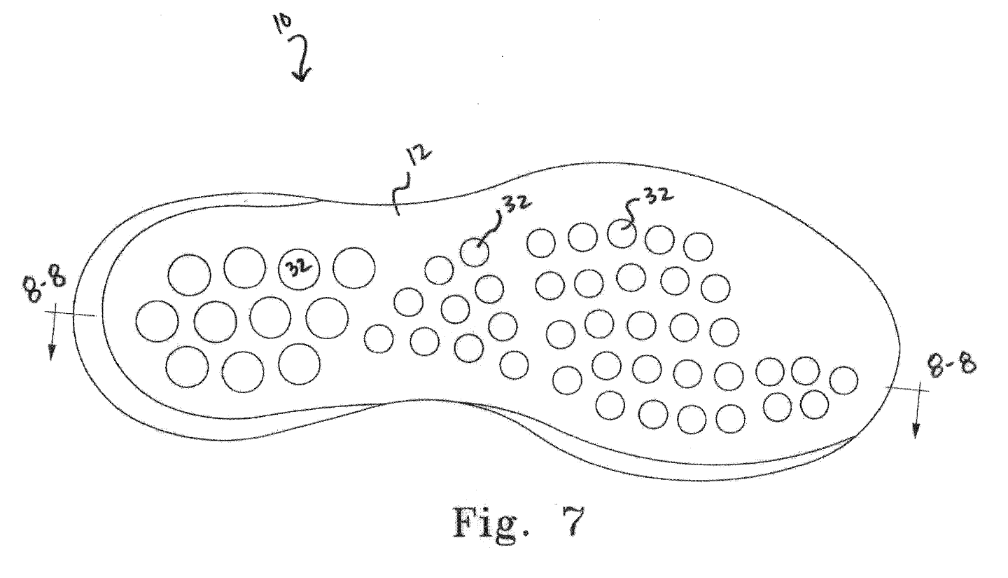

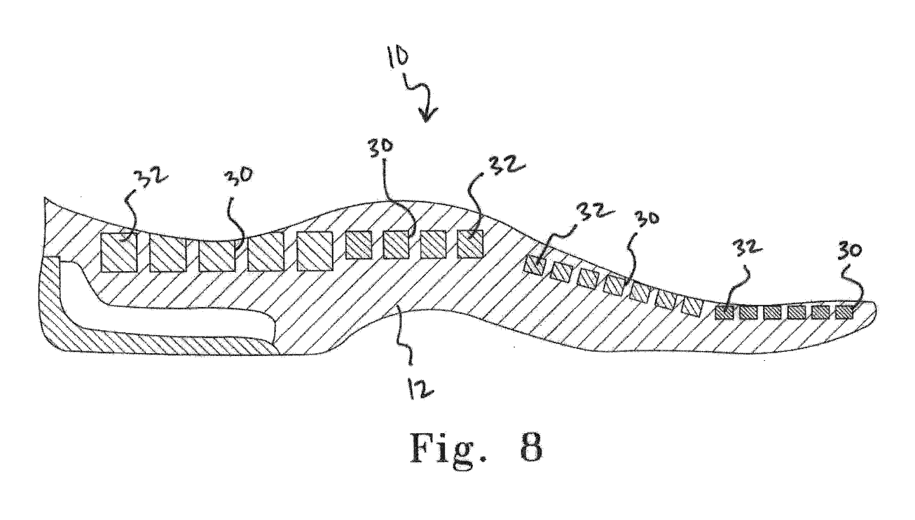

Referring to FIGS. 6-8, an alternative embodiment of the midsole 12 is provided. A plurality of strategically placed columns 30 and corresponding inserts 32 are provided for shock attenuation purposes. The number, size and material of the inserts 32 are designed to provide a customizable midsole based on the pressure mapping data obtained for a particular user. Compounds similar to those described above can also be applied to the inserts in whole or layered/veneered configurations.

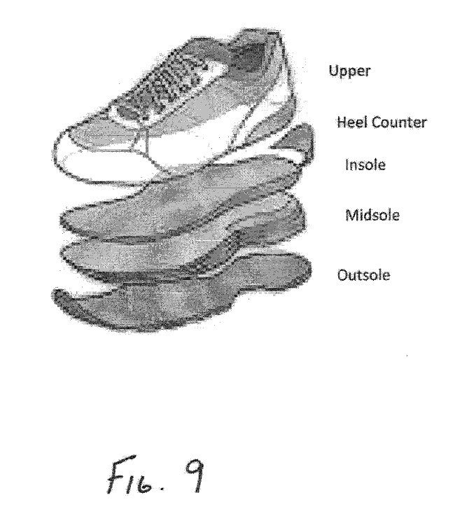

As shoes are typically comprised of a upper shoe (See FIG. 9), which encases the individual's foot; an insole which provides cushioning and contoured support of the arch; a midsole 10 which provides cushioning and controls foot movement during gait; and an outsole which provides traction at surface contact. A shoe's midsole is often the basis for a shoe's cushioning and stability systems. Cushioning is a focus of any midsole system. Cushioning addresses impact force resulting when the foot strikes the ground during walking, running, jumping or other athletic movement. Pressures are amplified in multiples of an individual's body weight when movements such as running, jumping or cutting occur. The basic intent of cushioning is to dissipate ground force reaction (GFR) in a way that equalizes force pressures throughout the body.

An individual's biomechanics and physiology, as well as the specific activity the athlete is participating in, determines the optimal cushioning characteristics of the shoe. Cushioning also determines the overall energy consumption of an athlete during activity. The body's inherent cushioning system of the body is centralized in the musculoskeletal system—the bones, muscles, ligaments and tendons, of the foot and leg. Energy is expended to operate this system with higher levels of energy depletion during intense activity. The cushioning characteristics of the shoe can help improving the efficiency of energy used and potentially reduce the energy needs of the athlete and elevate endurance.

An effective midsole also provides energy return to the wearer when it is compressed. Energy return provides lift to the foot that would normally require muscular contraction which would expend the athlete's energy store. The midsole can also be structured to control foot compression at the arch and the degree of ankle pronation or supination.

Foot pressure mapping utilizes sensors to measure the contact pressure between the foot and ground or another surface. One embodiment of a foot pressure mapping system utilizes a thin pad of various size and shape. In one embodiment, the pads are square, approximately 18″ by 18,″ and are composed of a matrix of small sensors and a cover. In another embodiment, the pressure mapping pads are foot shaped. When an individual stands on the pad, the sensors measure pressure at locations under the foot. The data obtained from the pressure mapping sensors reflect pressures under the heel, arch, metatarsals, and phalanges. The data is obtained and then transmitted to a memory storage unit, which can be internal or external to the pad. Pressure is force per unit area in a specific location. The data is transmitted to a storage device connected to the pad. In one embodiment, the storage device is an internal component of the retailer terminal computer. In another embodiment, includes a storage device external to a terminal computer and worn by the individual on a belt. In either embodiment, data is transferred from the storage device to the terminal. Software, or computer executable instructions, translates the data into quantitative measures and digital images representing a pressure distribution map which reflect the distribution of pressure across the foot at various stages of the foot strike.

The data is analyzed by a technician who assembles components within the compartments contained within the midsole. Alternatively, the data is analyzed by a computer system and dynamically produces a set of metrics and information which can be translated into the details necessary for manufacturing a customized shoe. The tuning of the midsole is guided by a system for obtaining information useful in determining the shape and movement characteristics of an individual's feet and transmitting the information to a manufacturing facility. The individual's information can be collected using footpads equipped with pressure sensors, then processed and transmitted via the internet. A manufacturing facility can be programmed to receive the transmitted information and assemble the components necessary to tailor the shoes cushioning and stability performance to the characteristic needs of the wearer.

Users of the system include individuals and retailers. The users' terminals are connected to the internet. The user terminals collect information about the individual's foot using plates or foot pressure scan pads equipped with pressure sensors. The information is processed at the user terminal and then sent to the manufacturer's terminal where a technician is guided through the assembly of appropriate insert components within the midsole compartments.

The user terminal includes a computer which is connected to pressure sensitive plate or equipped with a port (eg. USB) to facilitate connection with a sensor equipped foot pressure scan pad and external data storage device. The terminal includes a modem which connected to the internet. In one embodiment the terminal is a kiosk in a retail outlet. In another embodiment, the terminal is a desktop or laptop computer connected to the internet and accessible to the individual. In both embodiments, the terminals are capable of capturing, storing data from the sensor equipped foot pressure scan pad and transmitting the data via the internet to the manufacturing terminal or server. In these embodiments, the terminals capture digital information related to the individual's foot shape and movement throughout a foot strike, including the precise measurement and location of pressures generated by the foot's impact with the ground. The captured information can be displayed on the terminal's monitor and transferred to another computer terminal via an internet connection.

A foot pressure scan pad in accordance with an embodiment is a device equipped with sensors capable of measuring force pressures. Systems such as those developed by RS Scan, Inc. provide scan data captured at a variety of frequencies through plate and in-shoe device configurations. In one embodiment the pad resembles a rubber or foam mat or plate consisting of a layer of non-conductive material overlaying electronic sensor. The surface of the mat or plate is compressed as a result of the impact of the foot with the surface of the device. The minimum dimensions of the mat or plate is sufficient to accommodate an adult foot and may range as wide as one meter and several meters in length. The mat or plate is connected is generally used in a retail setting and is connected to a terminal via a USB or similar connection. In another embodiment, the pad is configured in the shape of a shoe insole and sized in a variety, common lengths and widths. The insole pad is placed in the individual's shoe and connected to a small data storage device worn by the individual. Data captured by the storage device is uploaded to the individual's computer terminal via a USB or similar connection which transmit the data to the manufacturer's terminal via an internet connection.

In operation, the individual stands, walks or runs across the surface of the pad. An electrical impulse is localized to the points of impact of the foot on the pad. The magnitude of electrical impulse is determined by the amount of compression of the foot pressure scan pad caused by the individual's foot. The discharge is detected by the pressure sensors located in proximity to the point of impact. The measure of the change in electrical current is indicative of the degree to which the sole of the individual's foot compresses the surface of the foot pressure scan pad, regardless of embodiment. The impulses are translated to a digital form capable of being transmitted to a terminal. The data is transmitted to the manufacturer's terminal to initiate production and assembly of the midsole.

The manufacturer's terminal receives the individual's pressure data, converting the data to a multi-dimensional image of the individual's foot. The data is also translated into a color coded image of the foot with the colors and numeric measures which identify the variances in pressures generated during the foot strike. The realized and differentiated pressures direct the component placed within each midsole compartment by a manufacturing and assembly technician. The shape of the component is determined by the midsole compartment in which it is placed. The density of the component and its cushioning characteristics is determined by the numeric and color coding of the image generated as a result of the data capture. Numeric ranges representing pressure measures guide the selection of each component. The manufacturing and assembly technician has a variety of different shaped and density components consisting of solid or layered material, spheres, cylinders or other geometric configurations sized to fit within the compartments contained in the midsole shell.

The midsole shell can vary in material density and compression properties and dimensions of length, width as well as arch position and height according to the data captured via the pressure scan. The pressure data will also indicate the center of balance of each of the individual's feet throughout the foot strike.

The pressure mapping system performs pressure measurements both barefoot and shod with static and dynamic with the pressure sensing plates or the in-shoe sensor device. Besides the static and dynamic pressures (N/sqcm) during the unroll of the foot, the system also quantifies the motion of the foot, temporal and spatial parameters of the unroll and of gait which are additional parameters to interpret the total gait pattern of the subject. The material density of the insert within a specific compartment is matched to the degree of pressure experienced at the location of the compartment during the foot strike.

The terminals and all hardware devices associated with capture and storage of the pressure data is operated by software. The software enables the hardware to capture and translate electronic impulses into digital, numeric and multi-dimensional images. The software also allows for the statistical and mathematical analysis and manipulation of the data captured. The software detects the position of the foot on the foot pressure scan pad. The sensors embedded within the foot pressure scan pad are activated by force applied to the pad at points of contact with the bottom of the foot. As the individual begins to walk, run or otherwise move their foot the pressures applied to the pad will change and the position of contact and associated pressures detected by the sensors will change accordingly.

The pressure data is transmitted to a manufacturing terminal via the internet as described above and provides information concerning the foot shape, size, physiology and biomechanical movement. The information is used for the manufacturing and assembly of a midsole customized to each of the individual's feet. The technician selects a midsole shell which contains a series of compartments located throughout the midsole. Based on the pressure data the technician selects components and inserts them into the indicated compartments.

### INCORPORATED BY REFERENCE

The following documents are hereby incorporated by reference in their entirety herein.
U.S. Pat. No. 6,820,353
U.S. patent application Ser. No. 10/985,722
Attachment A, 2 pages
Attachment B, 4 pages

The embodiments discussed here within as typical to the method and midsole design are subject to variations, substitutions, and modifications without departing from the scope of the invention. The system terminals and their function may vary. It is specifically intended that the present invention not be limited to the embodiments and illustrations contained herein, but rather that the present invention also include modified forms of those embodiments including portions of the embodiments and combinations of elements of different embodiments as come within the scope of the following claims.

We claim:

1. A customizable shoe comprising:
an outsole, a midsole and an upper portion,
the midsole comprising a plurality of performance regions customizable at least in part based upon foot pressure mapping information.

2. The shoe according to claim 1, wherein the performance regions include a heel region, an arch region a metatarsal region and a toe region.

3. The shoe according to claim 2, wherein each performance region include one or more customizable compartments.

4. The shoe according to claim 1, wherein shock attenuation within each compartment is based at least in part from a group of user-specific metrics.

5. The shoe according to claim 4, wherein the user-specific metrics are based at least in part upon information relating to a user's gait, physiology and biomechanical characteristics.

6. The shoe according to claim 3, wherein the customizable compartments have customizable inserts.

7. The shoe according to claim 6, wherein the customizable inserts are laminated foam layers.

8. A method for manufacturing a shoe comprising the following steps:
Performing a pressure scan of at least one foot;
Analyzing data obtained from the pressure scan;
Translating the pressure scan data;
Selecting midsole components based at least in part upon the translated pressure scan data;
Manufacturing the shoe at least in part based upon the selected midsole components.

12. A shoe midsole, comprising:
a structured holder having the shape and size of an user's foot, wherein the holder includes compartments distributed throughout heel, arch, metatarsal, and toe regions; and
the holder customizable based at least in part upon a specific user's pressure mapping data.

13. The shoe midsole according to claim 12, wherein the compartments are configured to receive inserts of various materials and substructures possessing shock attenuation properties.

14. The shoe according to claim 12, wherein compartment location and insert configuration control vertical deceleration, non-vertical deceleration and foot torsion during all phases of using the shoe.

15. The shoe according to claim 12, wherein the number of compartments vary within each foot region and the number of compartments are determined at least in part by vertical deceleration levels within each region.

16. A shoe midsole, comprising
a structured holder configured to match the shape of a foot, wherein the holder includes compartments distributed throughout a heel, arch, metatarsal, and toe foot regions, the compartments are configured with a flanged rim or groove.

17. The midsole according to claim 16, wherein each insert is configured with a groove or flange that matches that of the compartment in which it is placed.

18. The midsole according to claim 17, wherein the insert is secured in the compartment by matching the flange within the groove and adhesive materials.
